(19) United States
(12) Patent Application Publication
(10) Pub. No.: US 2018/0009541 A1
(43) Pub. Date: Jan. 11, 2018

(54) POWERED AIRBAG FOR AEROPLANE'S VERTICAL FALL DURING AN ACCIDENT

(71) Applicant: Ngoc Quy Pham, Ha Nam (VN)

(72) Inventor: Ngoc Quy Pham, Ha Nam (VN)

(21) Appl. No.: 15/513,566

(22) PCT Filed: Nov. 20, 2015
(86) PCT No.: PCT/VN2015/000016

§ 371 Date: Mar. 23, 2017

(30) Foreign Application Priority Data
Apr. 1, 2015 (VN) 1-2015-01100

(51) Int. Cl. B64D 25/00; B64C 1/14

(52) U.S. Cl. CPC B64D 25/00; B64C 1/14; B64D 2201/00

(57) ABSTRACT

The invention is about a powered airbag for planes in case of uncontrollable falling which makes the plane fall vertically with the head up. The invention includes the bonnet cover of the head 1, the hinges of the bonnet cover 17, the head cover of the plane 12, the structural frame of the head the plane 13, the container of gas-creating material 8, Valve to activate the airbag 9. There is a difference that the structural frame of the head of the plane 13 has a powered airbag 11, the flexible soft tube 10 which connects the powered airbag 11 to the frame of the head of the plane 13

### FIELD OF INVENTION

This invention is used in case of aeroplane accidents, that is a powered airbag is used to control the falling of a plane in the vertical direction.

### THE KNOWN SOLUTIONS

There have been some available methods used to support planes when having problems; however, many terrible accidents still occur including pilots' faults.

### TECHNICAL NATURE OF INVENTION

The purpose of this invention is to assist planes in case of having uncontrollable problems. When a plane loses its height and falls uncontrollably, the powered airbag will be activated which makes the falling goes vertically, the least damageable falling direction, especially into water.

To achieve the above purpose of the invention, the powered airbag consists of an airbag; a flexible soft tube connecting the airbag with the head of the plane; a container of gas-creating material for the airbag; a valve used to activate the airbag, a button for pilot to activate the powered airbag; a gravitational acceleration sensor used to automatically activate the powered airbag.

Principle of Operation:

In a normal condition, the airbag will be folded and installed to the head of the plane, in the bonnet. When a problem occurs, all possible methods to control the airplane fail and it starts falling uncontrollably, the pilot will activate the powered airbag, or the gravitational acceleration sensor will automatically activate the airbag. While falling, the very light powered airbag with a larger diameter than that of a plane will be able to turn the head of the plane upwards and the tail downwards due to a hindered force. At the same time, the power of the plane's engines can be used more to blow a force downwards against the gravitational acceleration by the pilot or the automatic system, this will lower considerably the damages to the plane. Preferably, a fall to the sea will bring the best result.

### FIGURE OF THE DRAWINGS

FIG. 1: a two-jet engine plane including the bonnet cover at the head, cockpit, body, body wings, jet engines, tail wings and the tail of the plane.

FIG. 2: position installing the container of gas-creating material, folded airbag, Button for pilot to activate and the gravitational acceleration sensor for the airbag.

FIG. 3: the head of the plane when the bonnet is open including the bonnet cover, the structural frame of the head and the position to install the airbag.

FIG. 4: the head of the plane after the installation of the powered airbag including the container of gas-creating material, valve for activation, the tube, the folded airbag and the structural frame of the head the plane.

FIG. 5: the cockpit at the head of the plane, the body, the body wings, the engines, the tail wings, the tail of the plane, the container of gas-creating material for the airbag, the valve for activation, the flexible soft tube and the activated powered airbag.

### DETAILED DESCRIPTION OF THE INVENTION

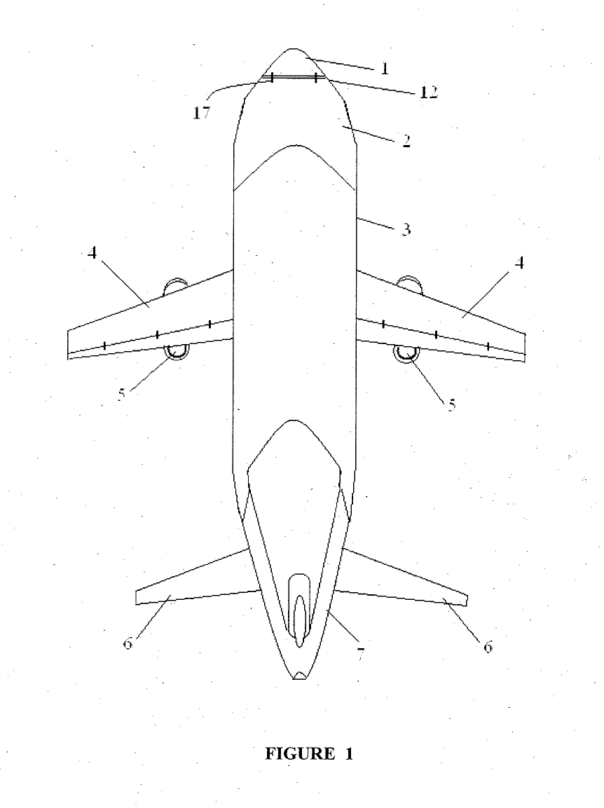

As shown in FIG. 1: a two-jet engine plane including the bonnet at the head 1, cockpit 2, body 3, body wings 4, jet engines 5, tail wings 6, the tail of the plane 7 and the hinges of the bonnet 17.

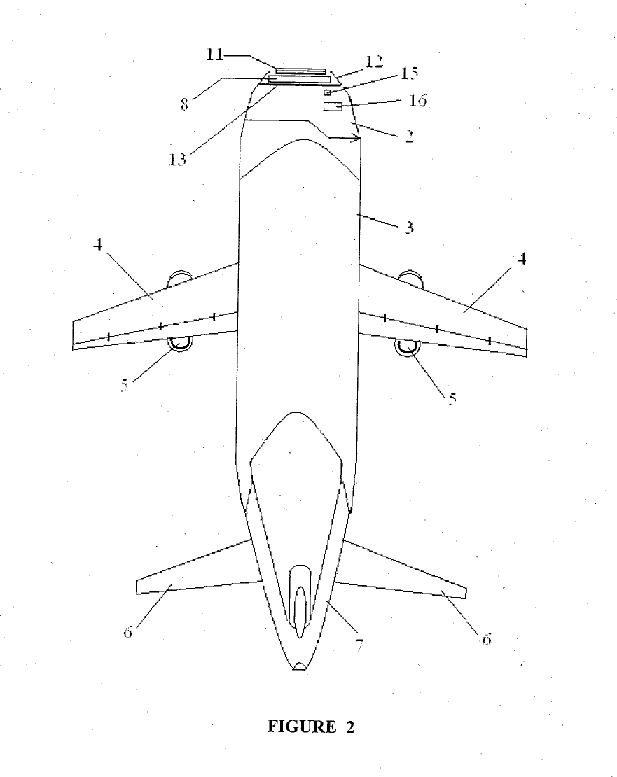

As shown in FIG. 2: position installing the container of gas-creating material 8, folded airbag 11, the bonnet cover of the head of the plane 12, the structural frame of the head 13 of the plane, button for pilot to activate the powered airbag 15 and the automatic gravitational acceleration sensor is used to activate the powered airbag 16.

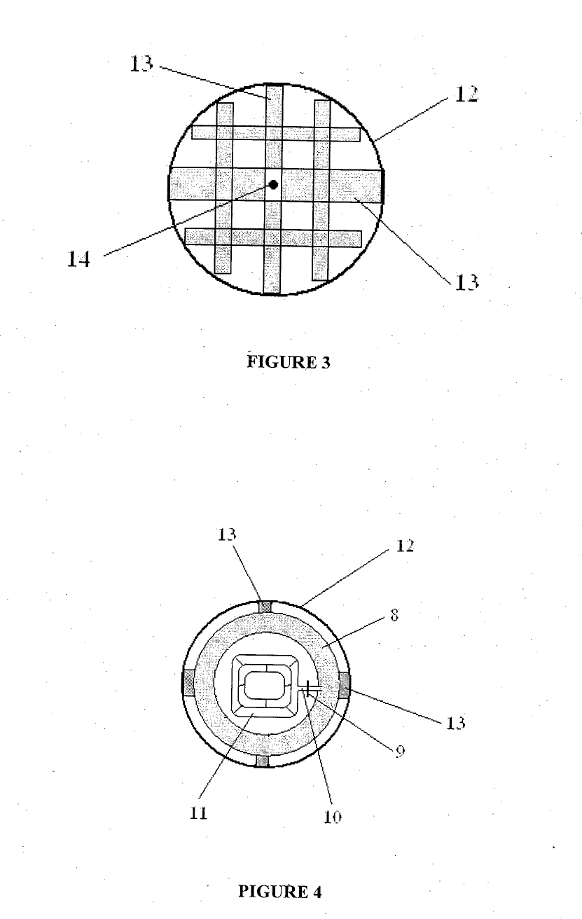

As shown in FIG. 3: the head of the plane when the bonnet is open including the bonnet cover 12, the structural frame of the head of the plane 13 and the position to install the airbag 14.

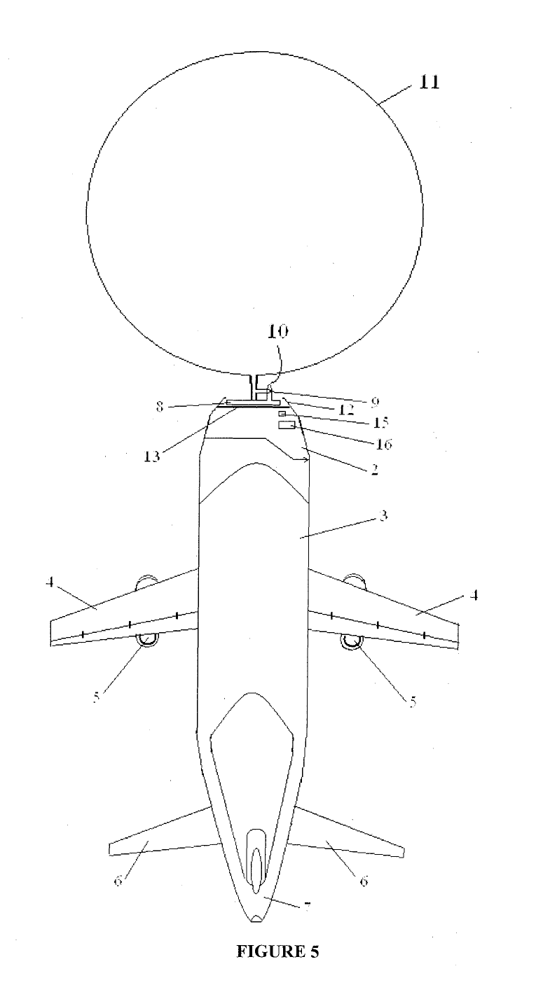

As shown in FIG. 4: the head of the plane after the installation of the powered airbag including the container of gas-creating material 8, valve for activation 9, the flexible soft tube 10, the folded airbag 11, the bonnet cover 12 and the structural frame of the head of the plane 13.

FIG. 5: the cockpit at the head of the plane 2, the body 3, the body wings 4, engines 5, tail wings 6, tail 7, the container of gas-creating material for the airbag 8, the valve for activation 9, the flexible soft tube 10, the activated powered airbag 11, the bonnet cover 12, the structural frame of the head 13, button for pilot to activate the airbag 15 and the automatic gravitational acceleration sensor 16.

### The Benefits of the Invention

lower considerably the damages to a plane when an accident occurs

If the plane falls vertically with the head up into the water, it may stay intact.

It may be helpful in searching for airplane accident at sea:

1. With purpose of the invention is about a powered airbag for aeroplane's vertical fall with the head up include: The bonnet cover of the head 1, the hinges of the bonnet cover 17, the head cover 12, the structural frame of the head the plane 13, the container of gas-creating material 8, valve to activate the airbag 9. There is a difference that the structural frame of the head of the plane 13 has a powered airbag 11, the flexible soft tube 10 which connects the powered airbag 11 to the structural frame of the head of the plane 13
